(19) United States
(12) Patent Application Publication
(10) Pub. No.: US 2005/0001924 A1
(43) Pub. Date: Jan. 6, 2005

(54) Image capturing apparatus

(75) Inventor: Tsutomu Honda, Sakai-shi (JP)

Correspondence Address: SIDLEY AUSTIN BROWN & WOOD LLP, 717 NORTH HARWOOD, SUITE 3400, DALLAS, TX, 75201, US

(73) Assignee: KONICA MINOLTA CAMERA, INC.

(21) Appl. No.: 10/812,576

(22) Filed: Mar. 30, 2004

(30) Foreign Application Priority Data
May 28, 2003 (JP) 2003-150689

(51) Int. Cl. H04N 5/232; G03B 17/00; G03B 13/00; G03B 3/00

(52) U.S. Cl. 348/348; 396/103

(57) ABSTRACT

An image capturing apparatus having a taking lens system capable of focus adjustment, a driver that drives the taking lens system for focus control, an input portion that accepts a shooting start instruction, a detector that detects a current position of the taking lens system, and a controller that determines whether the current position of the taking lens system is within an in-focus permissible range in response to the shooting start instruction, and starts shooting without driving of the taking lens system when the current position of the taking lens system is within said in-focus permissible range.

This application is based on Japanese Patent Application No. 2003-150689 filed in Japan on May 28, 2003, the entire content of which is hereby incorporated by reference.

### BACKGROUND OF THE INVENTION

1. Field of the Invention

The present invention relates to an image capturing apparatus such as a digital camera.

2. Description of the Related Art

An image capturing apparatus such as a digital camera shoots a subject in response to depression of the release button (shutter button). In order that the right moment to shoot the subject is not missed, it is desirable that the time from when the release button is depressed to when actual shooting is performed (release time lag) be minimized.

Based on this requirement, various techniques of reducing the release time lag have previously been proposed. According to these conventional techniques, the release time lag can be reduced to a certain extent.

However, according to all of these conventional techniques, in focus control, lens driving is further performed after the release button is depressed. This indicates that there is still room for reduction in release time lag.

### SUMMARY OF THE INVENTION

A principal object of the present invention is to provide an image capturing apparatus capable of quickly performing shooting without missing the right moment to shoot the subject.

Another object of the present invention is to provide an image capturing apparatus capable of reducing the time from when the release button is depressed to when actual shooting is performed (release time lag).

These objects are attained by providing an image capturing apparatus that comprises a taking lens system capable of focus adjustment, a driver that drives the taking lens system for focus control, an input portion that accepts a shooting start instruction, a detector that detects a current position of the taking lens system, and a controller that determines whether the current position of the taking lens system is within an in-focus permissible range in response to the instruction and starts shooting without driving the taking lens system when the current position of the taking lens system is within said in-focus permissible range.

### BRIEF DESCRIPTION OF THE DRAWINGS

These and other objects, advantages and features of the invention will become apparent from the following description thereof taken in conjunction with the accompanying drawings in which:

FIG. 1 is a front view of an image capturing apparatus 1;

FIG. 2 is a rear view of the image capturing apparatus 1;

FIG. 3 is a top view of the image capturing apparatus 1;

FIG. 4 is a view showing functional blocks of the image capturing apparatus 1;

FIG. 5 is a view illustrating the depth of field D (D1, D2);

FIG. 6 is a view illustrating an in-focus permissible range;

FIG. 7 is a view illustrating the in-focus permissible range;

FIG. 8 is a flowchart showing a shooting operation;

FIG. 9 is a flowchart showing the shooting operation; and

FIG. 10 is a flowchart showing operations according to a modification.

### DESCRIPTION OF THE PREFERRED EMBODIMENTS

Hereinafter, embodiments of the present invention will be described with reference to the drawings.

### A. First Embodiment

<A1. Structure>

<Structure Outline>

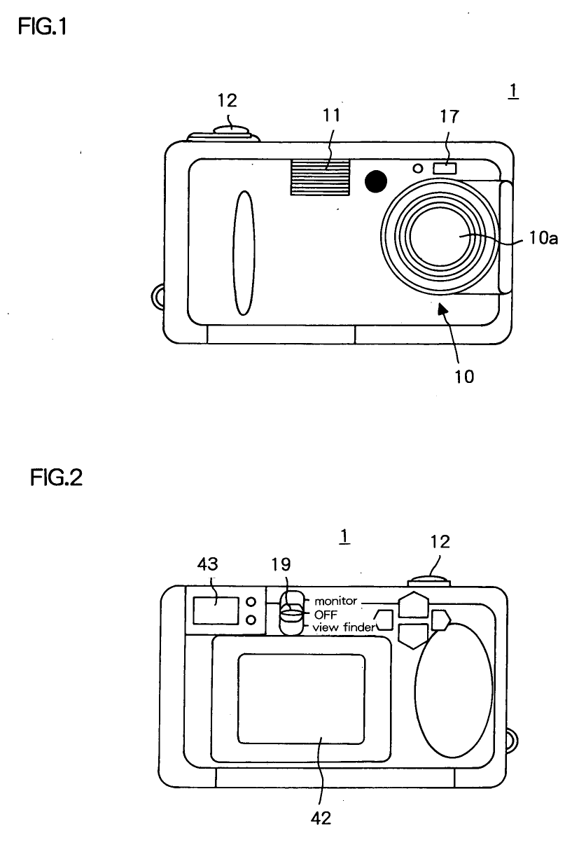

FIGS. 1 to 3 show the structure of a relevant part of an image capturing apparatus 1 according to an embodiment of the present invention. FIGS. 1 to 3 correspond to a front view, a rear view and a top view of the image capturing apparatus 1, respectively.

The image capturing apparatus 1 is structured as a digital camera, and has an image capturing portion 10 including a taking lens system 10a. The taking lens system 10a is capable of focus adjustment and focal length (zoom magnification) adjustment. That is, the taking lens system 10a has both of the functions of a focusing lens system and a zoom lens system.

The image capturing apparatus 1 has on its front a built-in flash 11 emitting light to the subject and a distance measurement sensor 17 measuring the distance from the image capturing apparatus 1 to the subject (main subject) (subject distance). As the distance measurement sensor 17, for example, various kinds of active sensors using infrared rays or the like or various kinds of passive (phase difference) sensors are usable.

The image capturing apparatus 1 has on its rear an LCD (liquid crystal display) monitor 42, an electronic viewfinder 43 and an EVF selector switch 19. Shot images and the like are displayed on the LCD monitor 42 and the electronic viewfinder 43. The EVF selector switch 19 is a slide switch. Whether shot images and the like are displayed on the LCD monitor 42, on the electronic viewfinder 43, or on none of them can be set by the EVF selector switch 19.

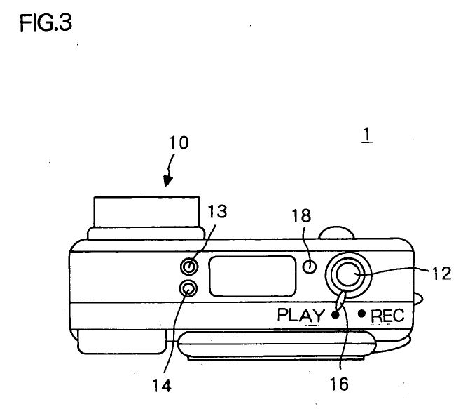

As shown in FIG. 3, the image capturing apparatus 1 has on its top a release button 12, a monitor enlargement switch 13, a quick shot switch 14, a mode selector switch 16 and a power button 18.

The power button 18 is a button for switching between energized state (ON state) and unenergized state (OFF state) in the image capturing apparatus 1.

The release button 12 is a two-stroke push switch capable of detecting a half depressed state (hereinafter, also referred to as state S1) and a fully depressed state (hereinafter, also referred to as state S2). When the user depresses the release button 12 to the half depressed state S1, the image capturing apparatus 1 determines that a “shooting preparation start” instruction input is accepted. When the user depresses the release button 12 to the fully depressed state S2, the image capturing apparatus 1 determines that a “shooting start” instruction input is accepted.

The monitor enlargement switch 13 is a switch for changing the enlargement ratio of the displayed images on the LCD monitor 42 and the electronic viewfinder 43. By depressing the switch 13, the shot images can be displayed being enlarged.

The mode selector switch 16 is a lever switch for switching between a playback mode and a shooting mode. By setting the lever of the mode selector switch 16 in a “REC” position, the image capturing apparatus 1 is set in the shooting mode, and by setting the lever of the mode selector switch 16 in a “PLAY” position, the image capturing apparatus 1 is set in the playback mode.

The quick shot switch 14 is a switch for switching the shooting mode (more specifically, the submode in the shooting mode). Specifically, every time the quick shot switch 14 is depressed, a normal mode and a quick shot mode are alternately selected. The quick shot mode is a mode in which the time from when the shooting start instruction input is made to when actual shooting is started (release time lag) is shorter than that in the normal mode. That is, in the quick shot mode, reduction in release time lag has higher priority than improvement in image quality (focus accuracy). In the “normal mode”, focus control can be performed more accurately than in the quick shot mode, and improvement in image quality (focus accuracy) has higher priority than reduction in release time lag.

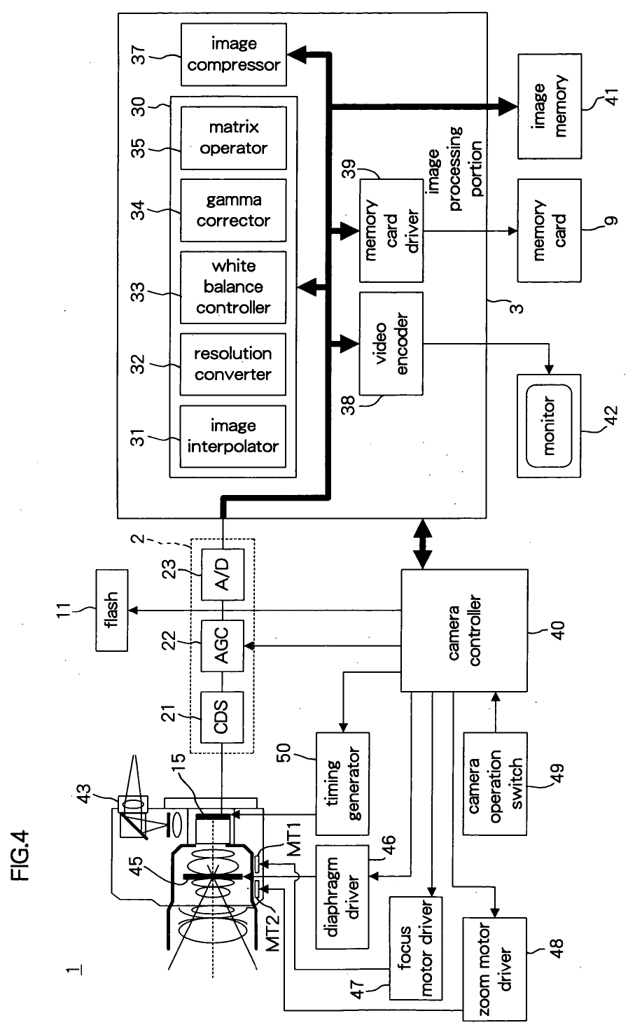

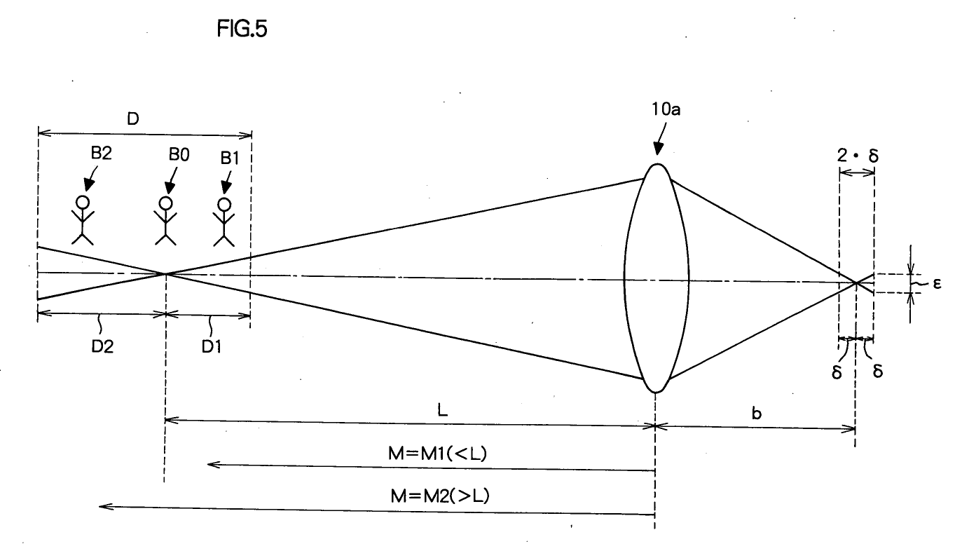

FIG. 4 is a view showing functional blocks of the image capturing apparatus 1.

The image capturing apparatus 1 has an image capturing sensor 15, a signal processor 2 connected to the image capturing sensor 15 so that data can be transmitted, an image processor 3 connected to the signal processor 2, and a camera controller 40 connected to the image processor 3.

The image capturing sensor 15 is structured as a single-chip area sensor having a pixel arrangement such that primary color transmitting filters of R (red), G (green) and B (blue) are arranged checkerwise. In the image capturing sensor 15, when charge accumulation is completed, photoelectrically converted signals are shifted to a light-intercepted transfer path and read out through a buffer, and image signals according to the subject are outputted. That is, the image sensor 15 is a so-called CCD image sensor.

The signal processor 2 has a CDS 21, an AGC 22 and an A/D converter 23.

The image signals outputted from the image sensor 15 are noise-removed by being sampled by the CDS 21, and are then sensitivity-corrected by the AGC 22.

The A/D converter 23 comprises a 14-bit A/D converter, and converts the analog signals normalized by the AGC 22 to digital form. On the digitized image signals, predetermined image processing is performed by the image processor 3, whereby an image file is generated.

The image processor 3 which includes a CPU and a memory has a digital processor 30, an image compressor 37, a video encoder 38 and a memory card driver 39.

The digital processor 30 has a pixel interpolator 31, a resolution converter 32, a white balance controller 33, a gamma corrector 34 and a matrix operator 35.

The image data inputted to the image processor 3 is written into an image memory 41 in synchronism with the readout by the image capturing sensor 15. Thereafter, accessing the image data stored in the image memory 41, the digital processor 30 performs various kinds of processing.

On the image data in the image memory 41, the R, G and B pixels are masked with their respective filter patterns by the image interpolator 31, and then, the G pixels are replaced with the average value of the two medians of four peripheral pixels by a median filter. On the R and B pixels, average interpolation is performed.

On the pixel-interpolated image data, the R, G and B pixels are independently gain-corrected by the white balance (WB) controller 33, whereby white balance adjustment of R, G and B is performed. In this white balance correction, a part of the shot subject that is originally white is estimated from the brightness and chroma data and the like, the average value, of each of R, G and B, of the part and G/R and G/B ratios are obtained, and based on these pieces of information, white balance is controlled as correction gains of R and B.

On the white-balance-corrected image data, a nonlinear conversion suitable for each output apparatus is performed by the gamma corrector 34, whereby the white-balance-corrected image data is converted into 8-bit data. Then, Y, R-Y and B-Y data are calculated from R, G and B by the matrix operator 35, and the calculated data are stored into the image memory 41.

Then, on the Y, R-Y and B-Y data stored in the image memory 41, the number of pixels set by the resolution converter 32 is reduced or thinned out in the horizontal and the vertical directions, and after compression processing is performed by the image compressor 37, the data are stored into a memory card 9 attached to the memory card driver 39.

The resolution converter 32 performs pixel thinning out also for image display, and forms a low-resolution image for display on the LCD monitor 42 or the electronic viewfinder 43. At the time of a preview, a low-resolution image of 640×240 pixels read out from the image memory 41 is encoded into NTSC (or PAL) signals by the video encoder 38, and with this as the field image, image playback is performed on the LCD monitor 42 and the electronic viewfinder 43.

The camera controller 40 which includes a CPU and a memory functions as a general controller in the image capturing apparatus 1.

Specifically, the camera controller 40 processes operation inputs that the user performs on a camera operation switch 49 having the release button 12, the monitor enlargement switch 13 and the like.

Moreover, the camera controller 40 controls the aperture value of the camera, for example, by opening and closing a shutter 44 through a diaphragm driver 46.

Further, the camera controller 40 controls the position of the taking lens system (more specifically, the lens system, for focus control, of the taking lens system) (hereinafter, referred to simply as “position of the taking lens system”) by driving a focus control motor MT1 through a focus motor driver 47. By doing this, control of the focus state (that is, focus control) of the taking lens system 10a is performed.

Moreover, the camera controller 40 changes the arrangement of a plurality of lens elements included in the taking lens system 10a by driving a zoom control motor MT2 through a zoom motor driver 48. By doing this, the focal length f of the taking lens system 10a is changed to thereby control the zoom magnification.

In a shooting standby state, the camera controller 40 displays an image for preview (live view image) shot every 1/30 second on the LCD monitor 42 or the like. The user can perform framing and the like while viewing the live view image. Thereafter, an actual shooting image is shot in response to depression of the release button 12, and after the actual shooting, the image taken by the actual shooting is displayed on the LCD monitor 42 for a predetermined time as an image for confirmation (after view image).

<A2. Basic Principle>

Subsequently, the basic principle of the focus control in this embodiment will be described.

At the point of time when the release button 12 is depressed to the fully depressed state S2 (that is, at the point of time when the shooting start instruction input is made), there are situations where the subject (main subject) is completely in focus and where the subject is not completely in focus. These situations are assumed even when focus control according to contrast AF or the like is performed before the release button 12 is depressed to the fully depressed state S2. This is because even when such focus control is performed in advance, there are cases where the subject is not completely in focus yet even at the point of time when the release button 12 is depressed to the fully depressed state S2 because of various factors such as a change of the framing area and a movement of the subject.

In situations where the subject is not completely in focus, if focusing involving lens driving is continued even after the release button 12 is depressed to the fully depressed state S2, a release time lag occurs due to the time involved in lens driving.

Therefore, in this embodiment, at the point of time when the release button 12 is depressed to the fully depressed state S2 (that is, when the shooting start instruction input is made), whether a condition C1 that the current position of the taking lens system is within an in-focus permissible range is satisfied or not is determined in response to the instruction input, and when the condition C1 is satisfied, shooting is started without the taking lens system being driven. By doing this, the occurrence of a release time lag can be avoided.

Whether the current position of the taking lens system is within the in-focus permissible range or not (that is, whether the condition C1 is satisfied or not) is determined as described below.

Generally, since images of objects at different distances are formed in different positions (imaging points), strictly speaking, “blurring” occurs. However, the blur is not recognized as a blur by humans when its diameter is smaller than a certain extent. At this time, the diameter ε of a shifted circle of an extent that is not recognized as a blur is called “the diameter of a permissible circle of confusion (permissible confusion circle diameter).” The permissible range in the direction of the depth in front and rear of the image surface that allows the size of the blur to be within the permissible confusion circle diameter is called “the depth of focus.” The subject image formed within the depth of focus is recognized as being in-focus by human eyes. The depth of focus δ symmetrically has the same size in front and rear of the correct image surface. Using the aperture value F and the permissible confusion circle diameter ε, the depth of focus δ is expressed by δ=±F×ε (see FIG. 5).

In accordance with the range of shift permitted on the image side (that is, the depth of focus), a range where subject position shifts are permitted is present also on the subject side. The permissible range on the subject side is called the depth of field. That is, when the subject is present within the depth of field, the subject is recognized as being in focus by human eyes.

FIG. 5 is a view illustrating the depth of field D (D1, D2). In FIG. 5, the taking lens system 10a is shown as one lens for the sake of simplicity.

A case is assumed where the taking lens system is present in a position that brings the subject B0 at a subject distance L optically completely in focus as shown in FIG. 5. At this time, a subject (for example, the subject B1) whose amount of shift (distance of shift) from the position at the distance L toward the front (toward the camera) is not more than a predetermined value D1 is shot as a sharp image, and can be regarded as being in focus. Likewise, a subject (for example, the subject B2) whose amount of shift (distance of shift) from the position at the distance L toward the rear (toward infinity) is not more than a predetermined value D2 is shot as a sharp image, and can be regarded as being in focus. As described above, subjects that are present in a range (that is, the depth of field) having widths of the distances D1 and D2 (D in total) from the position at the distance L toward the front and the rear, respectively, can be regarded as being in focus. The distance D1 is also called the front depth of field (see Expression 1), and the distance D2 is also called the rear depth of field (see Expression 2).

$$\begin{matrix}D1 = \frac{ɛ \cdot F \cdot {L}^{2}}{{f}^{2} + ɛ \cdot F \cdot L} & [ Expression 1 ] \\ D2 = \frac{ɛ \cdot F \cdot {L}^{2}}{{f}^{2} - ɛ \cdot F \cdot L} & [ Expression 2 ]\end{matrix}$$

Here, in Expressions 1 and 2, the front depth of field D1 and the rear depth of field D2 are each expressed as a function of the subject distance L, the focal length f, the aperture value F and the diameter of the permissible circle of confusion (permissible confusion circle diameter) ε. As the values L, f, ε, d and M (mentioned later) in Expression 1, Expression 2 and other expressions shown later, values expressed in the same unit (for example, mm) are used. The permissible confusion circle diameter ε is expressed, for example, as the following Expression 3 by use of the pitch (distance) d between pixels of the image capturing sensor 15 and a specific constant (real number) k (for example, k=1):
ε=k·d [Expression 3]

In this embodiment, using characteristics as described above, when the taking lens system is present in a position that brings the subject (main subject) within the depth of field, it is determined that the condition C1 is satisfied, and shooting is started without the lens being further driven.

More specifically, first, in response to the release button 12 being depressed to the fully depressed state S2, the current position x of the taking lens system at the time of the depression is detected, and the subject distance L corresponding to the current position x is obtained. The subject distance L is the subject distance of a subject that is brought completely in focus by the taking lens system in the position x, and is different from the actual subject distance M of the subject.

By comparing the subject distance L with the actual subject distance M obtained by the distance measurement sensor 17, it is determined whether the subject (main subject) to be shot is within the depth of field or not.

When the subject (B1) is present on the front side (right side of FIG. 5) of the position at the subject distance L, in other words, when the subject distance M is shorter than the distance L (L>M), whether the relationship of Expression 4 is satisfied or not is determined. Moreover, when the subject (B1) is situated on the far side (left side of FIG. 5) of the position at the subject distance L, in order words, when the subject distance M is longer than the distance L (L<M), whether the relationship of Expression 5 is satisfied or not is determined. When the equal sign holds (L=M), either of Expressions 4 and 5 may be used.
L−M≦D1(L≧M) [Expression 4]
M−L≦D2(L<M) [Expression 5]

The relationships of Expressions 4 and 5 can be integrated into Expression 6.
−D2≦L−M≦D1 [Expression 6]

Determination is performed by use of Expression 6.

When the relationship of Expression 6 is satisfied, the camera controller 40 can regard the subject as being in focus. At this time, shooting is immediately started without lens driving being further performed. By doing this, a subject present at the distance M can be shot so that the subject is in focus (or substantially in focus).

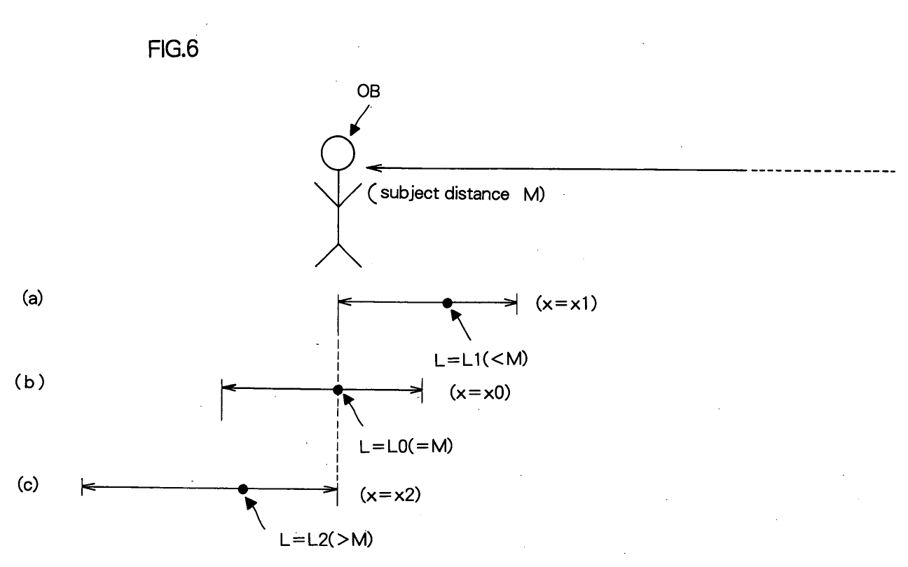

Determination as described above (determination of whether the relationship of Expression 6 is satisfied or not) corresponds to determination of whether the current position x of the taking lens system is within the in-focus permissible range or not. This will be explained with reference to FIG. 6.

(b) in FIG. 6 conceptually shows a case where the taking lens system is present in a position x0 where the subject OB at the subject distance 1M is completely in focus.

A case is assumed where the taking lens system moves from the position x0 that brings the subject at the subject distance M completely in focus to a position that brings a subject on the front side (lens side) of the position at the subject distance M completely in focus. When the taking lens system reaches a position x1 as shown at (a) in FIG. 6 with the movement in this direction, the subject at the subject distance M reaches the rear end point of the depth of field. This state corresponds to the state where the equal sign of Expression 5 holds.

On the other hand, a case is assumed where the taking lens system moves from the position x0 to a position that brings a subject on the rear side of the position at the subject distance M completely in focus. When the taking lens system reaches a position x2 as shown at (c) in FIG. 6 with the movement in this direction, the subject at the subject distance M reaches the front end point of the depth of field. This state corresponds to the state where the equal sign of Expression 4 holds.

As is apparent from FIG. 6, it is when the position of the taking lens system is a position somewhere between the position x1 and the position x2 that the subject OB to be shot is within the depth of field.

Therefore, determining whether Expression 6 is satisfied or not, in other words, “determining whether the current position of the taking lens system is a position that brings the subject within the depth of field or not” corresponds to determining whether the current position of the taking lens system is within the in-focus permissible range or not. At this time, the “in-focus permissible range” of the taking lens system is expressed as a range that brings the subject within the depth of field, specifically, is a given position between the position x1 and the position x2. The in-focus permissible range can be expressed also as a range determined based on the aperture value F, the permissible confusion circle diameter ε, the subject distances M and L and the focal length f (see Expression 6).

Moreover, since there is a predetermined correlation between the depth of field and the depth of focus as mentioned above, determining whether Expression 6 is satisfied or not, in other words, “determining whether the current position of the taking lens system is a position that brings the subject within the depth of field or not” also corresponds to “determining whether the current position of the taking lens system is a position that brings the image formation point of the subject by the taking lens system within the depth of focus or not.” In other words, the “in-focus permissible range” of the taking lens system is a range where the image formation point of the subject by the taking lens system is within the depth of focus (with respect to the image formation surface [described later]), or the “in-focus permissible range” of the taking lens system is a range where the image formation surface of the image sensor or the like is within the depth of focus with respect to the image formation point of the subject by the taking lens system.

Specifically, determination is made according to whether the relationship of Expression 7 is satisfied or not.
|L−M|·β²≦ε·F=δ [Expression 7]

Expression 7 is an approximate expression based on Expression 6. In Expression 7, conversion from a shift amount in the object space (subject space) to a shift amount in the image space is performed by multiplying the difference between the distances L and M by the square of the image magnification β (=f/M). That is, the left-hand side of Expression 7 can be considered to be a value obtained by converting the difference between the distances L and M into a displacement in the image space. “Whether the current position of the taking lens system is a position that brings the image formation point of the subject by the taking lens system within the depth of focus or not” can be determined according to whether the left-hand value is within the depth of focus δ or not.

Moreover, “whether the current position of the taking lens system is a position that brings the image formation point of the subject by the taking lens system within the depth of focus or not” may be determined by the following method:

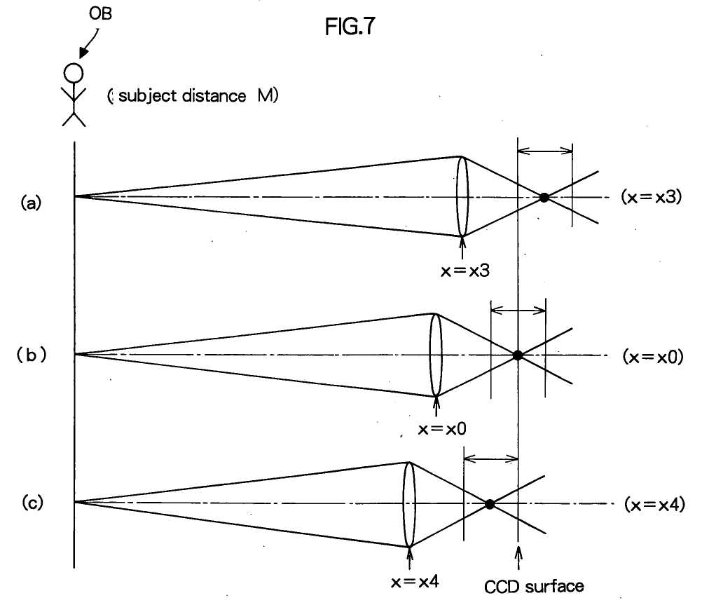

(b) in FIG. 7 shows a condition where an image of a subject at the subject distance M is formed just on the light receiving surface (also referred to as “CCD surface” or “image formation surface”) of the CCD image sensor when the position x of the taking lens system is the position x0. That is, the CCD surface coincides with the image formation surface. The position x0 can be expressed also as a position that brings the subject at the subject distance M completely in focus.

When the taking lens system is shifted rearward (toward the right side of the figure) from the position x0, the image formation point (surface) of the subject at the subject distance M is also shifted rearward. When the taking lens system reaches a position x3 (=x2) as shown at (a) in FIG. 7, the CCD surface reaches the rear end point of the depth of focus. That is, the position x3 is an end point of the in-focus permissible range.

On the other hand, when the taking lens system is shifted frontward (toward the left side of the figure) from the position x0, the image formation point (surface) of the subject at the subject distance M is also shifted frontward. When the taking lens system reaches a position x4 (=x1) as shown at (c) in FIG. 7, the CCD surface reaches the front end point of the depth of focus. That is, the position x4 is an end point of the depth of focus.

Moreover, since the shift amount of the lens position is slight compared to the subject distance M, the movement amount of the image formation point of the subject at the same distance M can be approximated to be equal to the movement amount of the taking lens system.

Therefore, by determining whether the shift amount of the current position x of the taking lens system with respect to the position x0 is within the depth of focus or not, “whether the current position of the taking lens system is a position that brings the image formation point of the subject by the taking lens system within the depth of focus or not” can be determined.

Specifically, the absolute value |x−x0| of the difference between the current position x of the taking lens system and the ideal lens position x0 that brings the subject at the subject distance M in focus is obtained. When a condition that the value |x−x0| is lower than (or not more than) the depth of focus (δ=F×ε) is satisfied, it is determined that “the current position of the taking lens system is a position that brings the image formation point of the subject by the taking lens system within the depth of focus.” At this time, since the depth of focus is expressed as the product of the aperture value F and the permissible confusion circle diameter ε, the “in-focus permissible range” can be expressed also as a range determined based on the aperture value F and the permissible confusion circle diameter ε.

<A3. Operation>

Subsequently, the shooting operation and the like in the first embodiment will be described in more detail.

In the first embodiment, a case where focus control is performed from the time of the turning-on of the power irrespective of the depression state of the release button 12 (that is, a case where full-time AF is performed) will be described. Focus control is started before the release button 12 is depressed, and lens driving for focus control is continued until the release button 12 is depressed to the fully depressed state S2. In this embodiment, the contrast method using contrast in the live view image is adopted as the focus control.

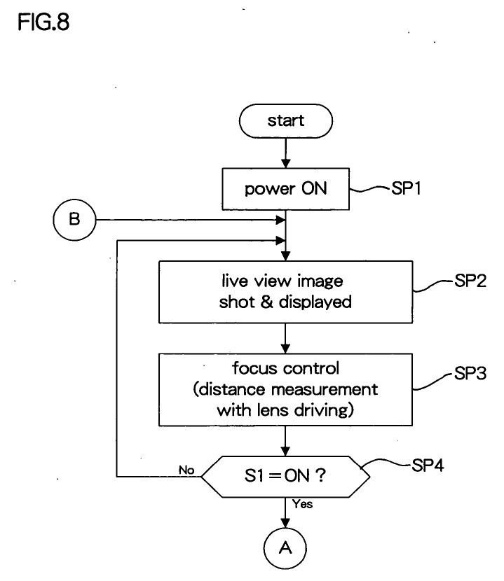

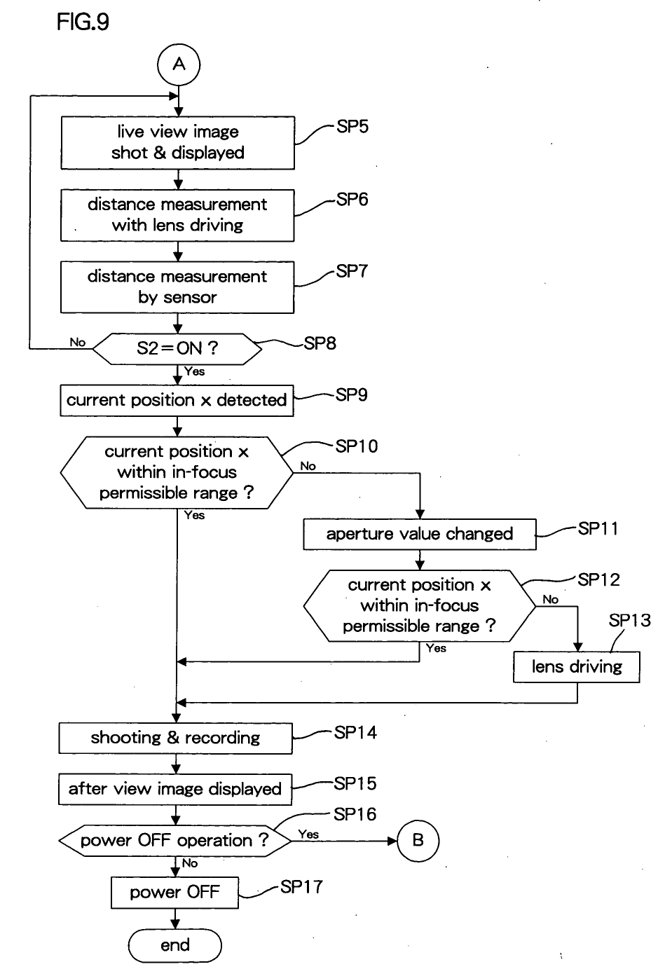

Moreover, in this embodiment, a case is assumed where the “shooting mode” by the “quick shot mode” is selected by the user, and with reference to FIGS. 8 and 9, the shooting operation in the quick shot mode will be described. FIGS. 8 and 9 are flowcharts showing the shooting operation and the like.

First, at step SP1, when the power is turned on in response to depression of the power button 18, a live view image is shot, and the shot live view image is displayed on the LCD monitor 42 (or the electronic viewfinder 43) (step SP2). Moreover, a focus control using changes in contrast in a plurality of live view images is performed (step SP3). This is a focus control by so-called “hill-climbing AF (or contrast AF).” Then, it is determined whether the release button 12 is depressed to the half depressed condition S1 or not (step SP4).

The operations at steps SP2, SP3 and SP4 are repeated at predetermined time intervals (for example, intervals of 1/30 second) until it is determined that the release button 12 is depressed to the half depressed state S1 at step SP4. Specifically, the camera controller 40 shoots a plurality of live view images while changing the position of the taking lens system by driving the taking lens system at predetermined time intervals, and performs in-focus determination by use of the obtained live view images. When the in-focus position is determined based on the result of the determination, the camera controller 40 moves the taking lens system to the in-focus position. By doing this, the subject can be brought in focus. After the subject has been brought in focus, the camera controller 40 monitors contrast changes in new live view images, and when the contrast change amount exceeds a predetermined value, again performs in-focus position determination and the like by the hill-climbing method. In this manner, focus control for the subject to be always in focus, that is, full-time AF (or also referred to as continuous AF) is performed.

Then, when it is determined that the release button 12 is depressed to the half depressed state S1 at step SP4, the process shifts to step SP5.

Specifically, like steps SP2 and SP3, distance measurement by hill-climbing AF is continued (steps SP5 and SP6), and measurement of the distance to the subject (subject distance M) (that is, distance measurement) is performed by use of the distance measurement sensor 17 (step SP7). Then, it is determined whether the release button 12 is depressed to the fully depressed state S2 or not (step SP8).

The operations at steps SP5, SP6, SP7 and SP8 are repeated at predetermined time intervals until it is determined that the release button 12 is depressed to the fully depressed state S2 at step SP8. Then, when it is determined that the release button 12 is depressed to the fully depressed state S2 at step SP8, determining that the shooting start instruction input is accepted, the process shifts to step SP9.

As mentioned above, for various reasons, at the point of time when the release button 12 is depressed to the fully depressed state S2, the current position of the taking lens system has not always completely reached the position that brings the subject completely in focus.

At step SP9 and succeeding steps, in response to depression of the release button 12 (shooting start instruction input), it is determined whether the condition C1 that the current position of the taking lens system at the time of the depression (the time of the input) is within the in-focus permissible range is satisfied or not. When the condition C1 is satisfied, shooting is started without the taking lens system being further driven for focus control. By doing this, the release time lag can be reduced.

Specifically, first, at step SP9, the current position x of the taking lens system (focusing lens system) is detected. Specifically, the camera controller 40 obtains the current position x based on sensor information by an encoder or the like provided in the taking lens system.

Then, at step SP10, it is determined whether the current position x is within the in-focus permissible range or not. Whether the current position of the taking lens system is within the in-focus permissible range or not is determined based on the above-described principle.

More specifically, first, the camera controller 40 obtains the subject distance L corresponding to the current position x of the taking lens system. The subject distance L is the subject distance of a subject that is brought completely in focus by the taking lens system in the current position x, and is different from the actual subject distance M of the subject. The correlation between the position x and the distance L is obtained based on a data table stored in a predetermined memory.

Then, at step SP10, the camera controller 40 determines whether the actual subject is within the depth of field or not by comparing the subject distance L with the actual subject distance M obtained by the distance measurement sensor 17. As the subject distance M, the value obtained as the measurement result at step SP7 is used. For this comparison, the permissible confusion circle diameter ε and the focal length f are obtained.

In this embodiment, determination is made by use of Expression 6.

When the relationship of Expression 6 is satisfied, the camera controller 40 regards the subject as being in focus, the process immediately shifts to the next step SP14 without lens driving being further performed, and shooting is started.

When the relationship of Expression 6 is not satisfied, the process proceeds to step SP11, and the camera controller 40 changes the aperture value F. Specifically, the diaphragm is further stopped down to change the aperture value F to a higher value.

When the aperture value is increased, the depth of field is increased, so that it is possible to satisfy the relationship of Expression 6. Therefore, at this step SP11, the aperture value F is changed so that the relationship of Expression 6 is satisfied.

For example, when the actual subject is present on the camera side of the camera side boundary position in the depth of field, a value satisfying Expression 8 is set as the new aperture value F. Specifically, the lowest one of the discrete values that satisfy Expression 8 and can be set as the aperture value is selected as the new aperture value F. Expression 8 is an expression obtained by substituting the right-hand side of Expression 1 into Expression 4 and solving it with respect to the aperture value F.

$$F ≧ \frac{( L - M ) \cdot {f}^{2}}{ɛ \cdot L \cdot M} \qquad [ Expression 8 ]$$

When the actual subject is present on the far side (infinity side) of the far side boundary position in the depth of field, a value satisfying Expression 9 is set as the new aperture value F. Expression 9 is an expression obtained by substituting the right-hand side of Expression 2 into Expression 5 and solving it with respect to the aperture value F.

$$F ≧ \frac{( M - L ) \cdot {f}^{2}}{ɛ \cdot L \cdot M} \qquad [ Expression 9 ]$$

At this time, in accordance with the change of the aperture value F, the shutter speed is also changed so that exposure is appropriate. When the aperture value F can be set, since it can be determined that the condition C1 is satisfied, the process proceeds from step SP12 to step SP14, and shooting is started. According to this, since shooting can be started only by changing the aperture without performing lens driving after the release button 12 is depressed to the fully depressed state, the release time lag can be reduced.

When the aperture value cannot be set, determining that the condition C1 is not satisfied, the process proceeds from step SP12 to step SP13.

At step SP13, in order that the subject is in focus, the lens (specifically, the focusing lens system) is exceptionally driven. Specifically, the focusing lens system is moved to the position that brings the subject at the subject distance M in focus (that is, the lens position corresponding to the subject distance M) (which position has been obtained at step ST7). By doing this, the condition C1 is satisfied. Then, the process proceeds to step SP14, and shooting is started.

When it is determined that the condition C1 is not satisfied at step SP10 and it is determined that the condition C1 is not satisfied also at step SP12 after the aperture value is changed at step SP11, shooting is started after the focusing lens system of the taking lens system is driven until the condition C1 is satisfied (step SP13). Contrast AF may be performed until the subject is in focus at step SP13.

At step SP14, an actual shooting image is shot, and the actual shooting image is recorded onto the memory card 9 as an image for recording.

Then, at step SP15, after view display for confirmation of the shot image (actual shooting image) is provided on the LCD monitor 42 for a predetermined time (for example, approximately several seconds).

At step SP16, whether the turning-off of the power is performed or not is determined. When the turning-off of the power is not performed, the process returns to step SP2, and the above-described operations are repeated. When the turning-off of the power is performed, the camera is turned off (step SP17), and the series of processing is finished.

As described above, according to the shooting operation of this embodiment, since shooting is started without the taking lens system being driven when the current position of the taking lens system is within the in-focus permissible range, the lens driving time is reduced, so that the time from when the shooting start instruction input is made to when shooting is actually started (that is, release time lag) can be reduced. In particular, even when the release button 12 is depressed from the half depressed state S1 to the fully depressed state S2 in a short time (for example, when the release button 12 is depressed from a state where it is not depressed at all to the fully depressed state S2 at one push), lens driving can be made not to be performed after the depression to the fully depressed state S2, so that the release time lag can be reduced. Moreover, since shooting is performed after it is confirmed that the current position of the taking lens system is within the in-focus permissible range, image quality degradation can be minimized.

Moreover, when the quick shot mode (a mode to reduce the time from when the shooting start instruction input is made to when shooting is actually started) is selected by the quick shot switch 14 for switching the shooting mode, the above-described focus control in which reduction in release time lag has higher priority is performed.

On the other hand, when the normal mode is selected, focus control in which the degree of in-focus state has higher priority is performed. Specifically, even when the release button 12 is depressed to the fully depressed state S2, normal hill-climbing AF involving lens driving is continued until it is confirmed that the subject is in focus. According to this, the subject can be more precisely in focus.

As described above, the user's intension as to which of the degree of in-focus state and the reduction in release time lag has higher priority can be reflected by mode selection (mode switching).

In the above-described embodiment, so-called full time AF is performed. Specifically, focus control is performed from immediately after the turning-on of the power. In other words, focus control is performed from before the shooting preparation start instruction input (half depressed state S1) or the shooting start instruction input (fully depressed state S2) is accepted, that is, before the release button 12 is depressed. Therefore, the possibility is high that the subject can be regarded as being in focus even if it is not completely in focus. Consequently, the possibility is comparatively high that shooting can be started without lens driving being performed in response to depression of the release button 12, and the possibility is comparatively low that lens driving is performed after the release button 12 is depressed. That is, the release time lag can be more effectively reduced.

Moreover, shooting is performed after the aperture value is changed so that the condition C1 is satisfied at step SP11. Consequently, the in-focus permissible range where the occurrence of blurring can be prevented is enlarged, so that the release time lag can be further reduced.

### B. Modifications, etc.

<Driving of Zoom Lens System>

While a case where the focusing lens system is driven at step SP13 is shown as an example in the above-described embodiment, the present invention is not limited thereto. At step SP13, shooting may be started after the focal length f is changed by driving the “zoom lens system” which is an optical member other than the focusing lens system. Specifically, after the zoom lens system of the taking lens system is moved toward the wide-angle side until the condition C1 is satisfied at step SP13, shooting is started.

When the zoom lens system is moved toward the wide-angle side, since the focal length f decreases, the depth of field increases (see Expressions 1 and 2). Thus, the subject can be brought in focus also by changing the focal length f to an appropriate lower value. The changed focal length f is set to a value that satisfies an inequality obtained by solving Expressions 4 and 5 with respect to the focal length f.

<Permissible Confusion Circle Diameter, etc.>

In the above-described embodiment, a case where a fixed value expressed as the product of the constant k and the pixel pitch d is used as the permissible confusion circle diameter ε is described. However, the permissible confusion circle diameter ε is not limited to a fixed value. Specifically, a value in accordance with the number of recording pixels may be used as the permissible confusion circle diameter ε.

In the case of film-based cameras, the permissible confusion circle diameter ε is frequently set to approximately 1/1000 to 1/1500 the diagonal length of the image plane; for example, in the case of 35-mm film, it is frequently set to approximately 1/30 mm. However, in the case of digital cameras, the permissible confusion circle diameter ε may be changed in view of the relationship with the number of pixels. For example, it may be performed to set the permissible confusion circle diameter ε to the width of one pixel (corresponding to a case where k=1) when the number of pixels is approximately 1600×1200 pixels and set it to the width of two or three pixels (corresponding to a case where k=2 or 3) when the number of pixels is approximately 640×480 pixels. As described above, the permissible confusion circle diameter ε may be changed according to the number of recording pixels.

While shooting is performed after the condition C1 is satisfied by changing the aperture value at step SP11, the present invention is not limited thereto.

For example, it may be performed to start shooting without driving the taking lens system also when the condition is not satisfied and perform, on the shot image, pixel number conversion processing to change the number of recording pixels so that the condition C1 is satisfied. According to this, the occurrence of blurring can be prevented while the release time lag is reduced. The pixel number conversion processing is performed by the resolution converter 32 under the control of the camera controller 40.

Specifically, when the number of recording pixels is set to 1600×1200 pixels (a comparatively large number of pixels), after the release button 12 is depressed, shooting is performed without lens driving being performed. After shooting is performed, whether the condition C1 is satisfied or not is determined, and when the condition C1 is not satisfied, the number of recording pixels is reduced. For example, the number of recording pixels is reduced to approximately 640×480 pixels (a comparatively small number of pixels). By the permissible confusion circle diameter ε being changed to a higher value in accordance with the reduction in the number of recording pixels, the front depth of field D1 and the rear depth of field D2 become high values, so that the condition 1 can be satisfied.

The number of recording pixels may be changed according to the shooting situation. Specifically, first, after the release button 12 is depressed to the fully depressed state S2, shooting is performed without lens driving being performed. Then, the number of recording pixels is set to a value that satisfies the condition C1, and the pixel number conversion processing is performed on the shot image.

For example, the number of recording pixels is stepwisely changed, the depth of field corresponding to each number of recording pixels is obtained, and the highest one of the numbers of recording pixels where the subject is within the depth of field is set as the number of recording pixels used when the shot image is recorded.

More specifically, first, the permissible confusion circle diameter ε corresponding to a first pixel number (1600×1200 pixels) is determined, and the depth of field corresponding to the determined permissible confusion circle diameter ε is obtained. Then, when the subject is within the depth of field corresponding to the first pixel number, the first pixel number is set as the number of recording pixels. When the subject is not within the depth of field corresponding to the first pixel number, the permissible confusion circle diameter ε corresponding to a second pixel number (approximately 640×480 pixels) is determined, and the depth of field corresponding to the determined permissible confusion circle diameter ε is obtained. Then, when the subject is within the depth of field corresponding to the second pixel number, the second pixel number is set as the number of recording pixels. Further, when the subject is not within the depth of field corresponding to the second pixel number, the permissible confusion circle diameter ε corresponding to a third pixel number (approximately 320×240 pixels) is determined, and the depth of field corresponding to the determined permissible confusion circle diameter ε is obtained. Then, it is determined whether the subject is within the depth of field corresponding to the third pixel number or not. Thus, the number of recording pixels where the subject is within the depth of field may be set as the number of recording pixels used when the shot image is recorded.

It may be performed to start shooting without driving the taking lens system also when the condition is not satisfied and perform, on the shot image, edge enhancement to further enhance the edge. The edge enhancement is performed by the image processor 3 under the control of the camera controller 40. According to this, visible blurring can be reduced.

<Degree of Quickness>

While in the above-described embodiment, a case where switching between the “quick shot mode” and the “normal mode” is made by the quick shot switch 14 and in the quick shot mode, determination is performed based on a one-step in-focus permissible range is shown as an example, the present invention is not limited thereto. For example, a plurality of levels of quick shot modes may be settable. In other words, the degree of request for reduction in release time lag may be set as the “degree of quickness.”

Specifically, the user selects in-focus permissible ranges of three levels from a first level to a third level by use of a menu screen displayed on the LCD monitor 42. The camera controller 40 may change the width of the in-focus permissible range according to the degree of quickness. Specifically, when the first level with the lowest degree of quickness is selected, the smallest in-focus permissible range is set. When the third level with the highest degree of quickness is selected, the largest in-focus permissible range is set. When the second level with an intermediate degree of quickness is selected, an in-focus permissible range is set that is larger than the first in-focus permissible range and smaller than the third in-focus permissible range. Then, whether or not shooting is started without the taking lens system being driven may be determined based on the in-focus permissible range in accordance with the selection. According to this, finer settings can be made.

<Subject Distance M, etc.>

The above-described embodiment corresponds to a case where the subject distance M from the image capturing apparatus 1 to the subject is actually measured by the distance measurement sensor 17 and whether the taking lens system is present within the in-focus permissible range or not is determined based on the measured subject distance M.

However, the present invention is not limited thereto. It may be performed to preset the subject distance M from the image capturing apparatus 1 to the subject and determine whether the position of the taking lens system in hill-climbing AF is within the in-focus permissible range or not based on the set subject distance M.

For example, the hyperfocal length M0 of Expression 10 may be set as the distance M.

$$M 0 = \frac{{f}^{2}}{ɛ \cdot F} \qquad [ Expression 10 ]$$

Here, although the subject cannot be always brought completely in focus because the original position of the subject is unknown, by setting the hyperfocal length M0 as the distance M, subjects in a comparatively large range can be brought in focus. That is, the probability that the subject is within the depth of field can be improved.

For example, a distance shorter than the hyperfocal length M0 may be set as the distance M (also referred to as Case 1), and in that case, the in-focus permissible range satisfying Expression 6 is a range, comparatively on the near side, of the range in which the focusing lens system can be driven. In this case, if the taking lens system is present on the nearest side in the in-focus permissible range, the depth of field is a small range.

On the contrary, when the hyperfocal length M0 is set as the distance M, the in-focus permissible range is a range, on the farther side than that in the above-described case (Case 1), of the range where the focusing lens system can be driven. In this case, even if the taking lens system is present on the nearest side in the in-focus permissible range, the depth of field is larger than that in the above-described case (Case 1). Moreover, when the taking lens system is present in a position that brings a subject at the hyperfocal length M0 completely in focus, subjects in a large range from the midpoint of the hyperfocal length M0 to infinity are present within the depth of field. Further, when the taking lens system is present in a position that is within the in-focus permissible range and brings completely in focus a subject in a position farther than the position at the hyperfocal length M0, subjects in a large range from the position at a predetermined distance to infinity are within the depth of field.

As described above, when the hyperfocal length M0 is set as the distance M, subjects in a comparatively large range are within the depth of field when the taking lens system is situated in any position within the in-focus permissible range. A distance longer than the hyperfocal length M0 may be set as the distance M.

Whether the physical position of the taking lens system in hill-climbing AF is within the in-focus permissible range or not may be determined after the in-focus permissible range is directly determined instead of indirectly determining the in-focus permissible range through the subject distance M. Specifically, the in-focus permissible range may be set as a fixed range from a first reference position (fixed position) to a second reference position (fixed position). For example, as the first reference position, a lens position that brings a subject at the hyperfocal length M0 completely in focus or a lens position that brings completely in focus a subject at a distance that is a fraction (for example, ½) of the hyperfocal length M0 is adopted. Moreover, as the second reference position, a lens position that brings completely in focus a subject at a distance that is several times as long as the hyperfocal length M0 is adopted. As the second reference position, a lens position that brings the subject at infinity completely in focus may be adopted. As the in-focus permissible range, it is desirable to set a predetermined range including a lens position that brings a subject at the hyperfocal length M0 completely in focus as described above.

The above-described determination method not involving measurement of the subject distance M by a distance measurement sensor or the like is also applicable to cameras having a zoom lens system as described above. In this case, since it is unnecessary to provide a distance measurement sensor, effects by a reduction in the number of parts are obtained. However, the present invention is not limited thereto. This determination method may be applied to fixed focal length cameras. Moreover, this determination method is suitable for fixed focal length cameras from the following viewpoint: Fixed focal length cameras have a comparatively simple structure compared to zoom cameras, and reduction in the number of parts is highly required thereof. Therefore, by using for such fixed focal length cameras the above-described determination method not using a distance measurement sensor, whether to further perform lens driving or not can be easily determined while the request for reduction in the number of parts is satisfied in fixed focal length cameras having a comparatively simple mechanism.

<AF Method, etc.>

In the above-described embodiment, a case is described where the present invention is applied to full-time AF (continuous AF). However, the present invention is not limited thereto. The present invention may be applied, for example, to one-shot AF as described below.

Although similar to the above-described embodiment for the most part, this modification is different therefrom in that when in-focus state is obtained after the release button 12 is depressed to the half depressed state S1, lens driving is stopped (so-called focus lock is performed). This focus control is called “one-shot AF.”

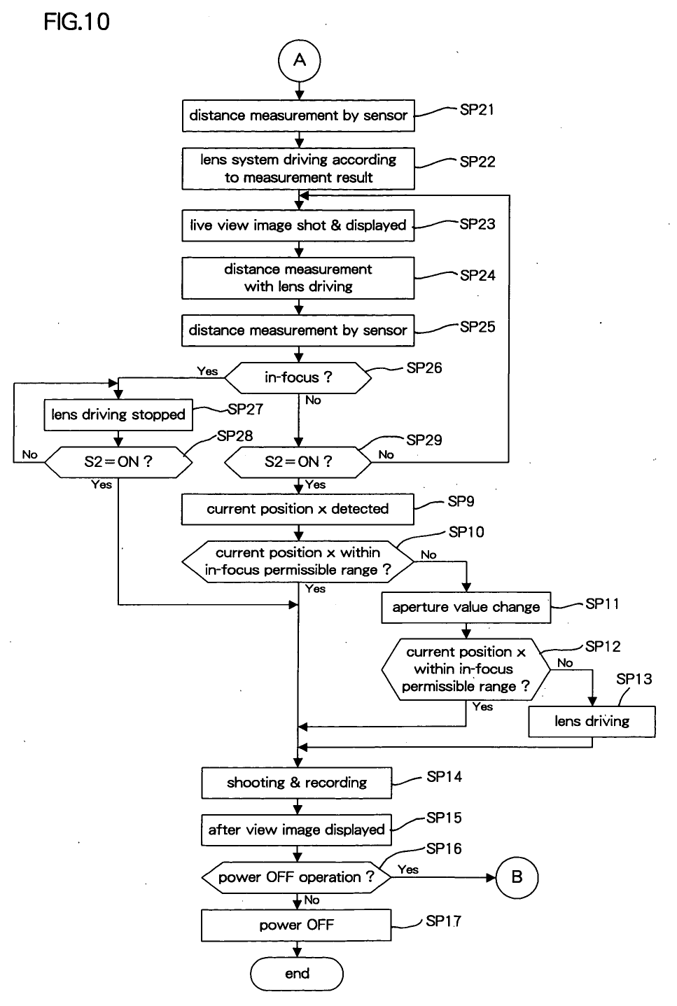

FIG. 10 is a view showing part of a flowchart according to a modification. Operations similar to steps SP1 to SP4 of FIG. 8 are performed before operation at step SP21. In the following, operations according to the modification will be described with reference to FIGS. 8 and 10.

When it is determined that the release button 12 is depressed to the half depressed state S1 at step SP4 (FIG. 8), the process shifts to step SP21 (FIG. 10).

Specifically, measurement of the distance to the subject (subject distance M) (that is, distance measurement) is performed by use of the distance measurement sensor 17 (step SP21), and the taking lens system is driven to a position that brings a subject at the subject distance M in focus (step SP22). By doing this, focus control can be performed at high speed. In particular, even when the subject is not in focus by comparatively low speed focusing (step SP6), the subject can be brought in focus at high speed with a certain degree of accuracy.

Then, live view shooting and display (step SP23) and distance measurement by hill-climbing AF (step SP24) are continued. By doing this, focusing is performed with a higher degree of accuracy. The measurement of the subject distance M by the distance measurement sensor (step SP25) is also continued. The result of the measurement is used at succeeding step SP10, etc.

When it is determined that in-focus state is obtained at step SP26, lens driving is stopped (step SP27), and the process waits until the release button 12 is depressed to the fully depressed state S2 (step SP28). When the release button 12 is depressed to the fully depressed state S2, the process proceeds to step SP14. Steps SP14 to SP17 are similar to the operations in FIG. 9.

When it is determined that in-focus state is not obtained at step SP26, it is determined whether the release button 12 is depressed to the fully depressed state S2 or not (step SP29). When the release button 12 is not depressed to the fully depressed state S2, the process returns to step SP23, and the operations at steps SP23 to SP26 are repeated. When the release button 12 is depressed to the fully depressed state S2, the process proceeds to step SP9. Steps SP9 to SP17 are similar to the operations in FIG. 9.

That is, when the release button 12 is further depressed to the fully depressed state S2 before in-focus state is obtained after the release button 12 is depressed to the half depressed state S1, the determinations at steps SP9 to SP13 are performed. According to this, the release time lag can be reduced.

Moreover, while a case where focusing is performed by use of the contrast method is shown as an example in the above-described embodiment, etc., the present invention is not limited thereto. For example, focusing may be performed by use of only a method other than the contrast method (a phase difference method, an external light active method, etc.). Then, the determinations at steps SP9 to SP13 may be performed when in-focus state is not obtained even by such a focusing operation at the point of time when the release button 12 is depressed to the fully depressed state S2. By doing this, the release time lag can also be reduced.

Although the present invention has been fully described by way of examples with reference to the accompanying drawings, it is to be noted here that various changes and modifications will be apparent to those skilled in the art. Therefore, unless otherwise such changes and modifications depart from the scope of the present invention, they should be construed as being included therein.

1. An image capturing apparatus comprising:
a taking lens system capable of focus adjustment;
a driver that drives the taking lens system for focus control;
an input portion that accepts a shooting start instruction;
a detector that detects a current position of the taking lens system; and
a controller that determines whether the current position of the taking lens system is within an in-focus permissible range in response to the shooting start instruction, and starts shooting without driving of the taking lens system when the current position of the taking lens system is within said in-focus permissible range.

2. The image capturing apparatus as claimed in claim 1, wherein said in-focus permissible range of the taking lens system is a range where imaging point of the subject by the taking lens system is within a depth of focus.

3. The image capturing apparatus as claimed in claim 1, wherein said in-focus permissible range of the taking lens system is a range where a subject is within a depth of field.

4. The image capturing apparatus as claimed in claim 1, further comprising:
switching member that switches a plurality of submodes in a shooting mode; and
wherein said controller determines whether the current position of the taking lens system is within an in-focus permissible range when a predetermined submode in said shooting mode is selected by said switching member.

5. The image capturing apparatus as claimed in claim 1 wherein said input portion accepts a shooting preparation start instruction, and said controller performs a focus control before the acceptance of said shooting preparation start instruction.

6. The image capturing apparatus as claimed in claim 1, further comprising:
measuring portion that measures a subject distance from the image capturing apparatus to the subject; and
wherein said controller determines whether the current position of the taking lens system is within an in-focus permissible range based upon the subject distance.

7. The image capturing apparatus as claimed in claim 1, further comprising:
setting portion that sets a subject distance from the image capturing apparatus to the subject; and
wherein said controller determines whether the current position of the taking lens system is within an in-focus permissible range based upon the subject distance set by said setting portion.

8. The image capturing apparatus as claimed in claim 1 wherein said controller changes a value of an aperture without driving the lens system when the current position of the taking lens system is not within said in-focus permissible range so that the current position of the taking lens system is within said in-focus permissible range, and then starts shooting.

9. The image capturing apparatus as claimed in claim 1 wherein said controller starts shooting even when the current position of the taking lens system is not within said in-focus permissible range; and
further comprising:
edge enhancement portion that performs edge enhancement on a captured image.

10. The image capturing apparatus as claimed in claim 1 wherein said controller starts shooting even when the current position of the taking lens system is not within said in-focus permissible range; and
further comprising:
pixel number conversion portion that changes the number of recording pixels so that the current position of the taking lens system is within said in-focus permissible range.

11. The image capturing apparatus as claimed in claim 10 wherein said pixel number conversion portion reduces the number of recording pixels.

12. The image capturing apparatus as claimed in claim 10 wherein said pixel number conversion portion sets the number of recording pixels so that the current position of the taking lens system is within said in-focus permissible range.

13. The image capturing apparatus as claimed in claim 1 wherein said controller drives a focus lens of the taking lens until the current position of the taking lens system is within said in-focus permissible range, and then starts shooting.

14. The image capturing apparatus as claimed in claim 1 wherein said controller drives a zoom lens of the taking lens until the current position of the taking lens system is within said in-focus permissible range, and starts shooting.

15. The image capturing apparatus as claimed in claim 4, further comprising:
setting portion that sets a degree of quickness in said predetermined submode; and
wherein said controller changes said in-focus permissible range in accordance with the set degree of quickness.

16. A method for capturing an image, said method comprising the steps of:
driving a taking lens system for focus control;
accepting a shooting start instruction;
detecting a current position of the taking lens system;
determining whether the current position of the taking lens system is within an in-focus permissible range in response to the shooting start instruction; and
starting a shooting without driving of the taking lens system when the current position of the taking lens system is within said in-focus permissible range.

17. The image capturing method as claimed in claim 16 wherein said in-focus permissible range of the taking lens system is a range where imaging point of the subject by the taking lens system is within a depth of focus.

18. The image capturing method as claimed in claim 16 wherein said in-focus permissible range of the taking lens system is a range where a subject is within a depth of field.

19. The image capturing method as claimed in claim 16, further comprising the steps of:
accepting a shooting preparation start instruction; and
controlling a focus before the acceptance of said shooting preparation start instruction.
